(19) United States
(12) Patent Application Publication
(10) Pub. No.: US 2007/0174697 A1
(43) Pub. Date: Jul. 26, 2007

(54) Generic, WSRF-compliant checkpointing for WS-Resources

(75) Inventors: Titos Saridakis, Espoo (FI); Heikki Verta, Helsinki (FI)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 11/335,276

(22) Filed: Jan. 19, 2006

(51) Int. Cl. G06F 11/00

(52) U.S. Cl. 714/19

(57) ABSTRACT

A generic, WSRF-compliant checkpointing mechanism for grid services that is based upon the information found in a resource properties document. The resource properties document gives the structure of the entire state of a WS-Resource as a set of properties and their values. The checkpointing mechanism also is based upon the operations for retrieving and replacing the resource properties document of a WS-Resource.

### FIELD OF THE INVENTION

The present invention relates generally to grid computing and services. More particularly, the present invention relates to mechanisms for taking of checkpoints of grid services for use in future potential rollbacks.

### BACKGROUND OF THE INVENTION

Grid computing is a system for developing flexible, scalable and cost-effective platforms that virtualize the computational resources of a system and accommodate a wide variety of services. One case where grids may provide significant benefits is in replacing traditional, special purpose equipment of telecom operators, and host all possible services the operators would like to offer. When developing telecom grids, special attention is needed to ensure the dependability of the grid and the services deployed on it. One threat to the dependability of a service at runtime is the occurrence of errors, which may cause a service to produce incorrect results or deliver its results late (or not at all). To deal with errors and retain an expected level of dependability, a service relies to a great extent on a fault tolerance technique.

Fault tolerance techniques prescribe how to detect errors and what corrective actions to take in order to remove the effects of errors from the system. One broad category of corrective actions, referred to herein as rollback recovery, removes the effects of an error by bringing or “rolling” the system back to a state that the system had reached prior to the error. Such error-free states, to which the system can be rolled back after an error, are saved during the normal, error-free execution of the system as checkpoints. Another broad category of corrective actions is based on replica groups; a part of the system is replicated so that, if an error occurs in one replica, the rest of the replicas can deliver the expected functionality. In replica groups, checkpoints are used to initialize newly created or newly activated replicas to the same state as the rest of the replicas in the group. Therefore, checkpoints play a central role in many fault tolerance techniques. For this reason, it is imperative to facilitate the process of saving checkpoints of grid services on stable storage media or devices. It is also important to facilitate the loading of saved checkpoints back to grid services in order to enable the application of a wide range of fault tolerance techniques in ensuring the dependability of a grid.

Standardization work in grid services has converged with the standardization of web services, resulting in a unified concept for a grid service and a stateful web service. This is referred to as the WS-Resource and comprises a stateless web service that contains the service logic and a stateful resource that contains the service data. The Web Service Resource Framework (WSRF), which is discussed at www.globus.org/wsrf/specs/ws-wsrf.pdf, specifies how to expose a state of a state-full service, such as a grid service usually is, in the interface of an otherwise stateless web service. Since WSRF is the standardized method of describing grid services, providing a generic support for taking checkpoints of grid services must comply to WSRF.

The problem of taking checkpoints in a distributed system has been at issue since the dawn of fault tolerance in the 1960's. In many cases, the extraction of the state of a service, which was stored in stable storage as a checkpoint, was considered to be an inherent capability of the service itself. Two forces drove this assumption. First, services that needed to be fault tolerant explicitly considered fault tolerance requirements in their design. Therefore, these services provided a way to export their state upon request from the fault tolerance mechanism which was responsible for taking checkpoints. Second, providing a generic mechanism, which would serve equally well all services, was not possible because there was no generic way for individual services to represent their states.

Assuming the common separation of the software in operating system (OS), middleware and application layers, one issue that checkpoint-based rollback recovery techniques have to address is the layer responsible for taking checkpoints. Taking checkpoints at the operating system (OS) layer provides transparency of the checkpoint mechanism to the middleware and application layers. This means that, by putting in place the checkpoint mechanism once for a given OS, the middleware and all applications running on that OS can take advantage of it without necessitating any modification. On the other hand, deducing when middleware and applications are in a meaningful state that can checkpointed requires a substantial effort at the OS level. This category of checkpoint techniques is referred to as transparent checkpoints.

As an alternative to this approach, the application software can be responsible for taking checkpoints. Although this solves the problem of identifying meaningful application states that can be checkpointed, it also implies that the checkpoint mechanism is application-specific. Therefore, all applications that need checkpoint-based rollback recovery have to be modified to integrate the checkpoint mechanism under this approach. This category of checkpoint techniques is referred to as explicit checkpoints.

Taking checkpoints at the middleware level attempts to combine the benefits of both explicit checkpoints and checkpoints while minimizing the compromises. Applications are not modified as long as they run on top of the middleware that provides the checkpoint mechanism while, being close to the application layer, it is easier to identify meaningful application states at the middleware level. This category of checkpoint techniques is referred to as implicit checkpoints. This category also includes compiler-assisted checkpoint insertion.

In explicit checkpoints, the application has the responsibility to trigger checkpoints. In implicit and transparent checkpoints, however, where the middleware or OS triggers checkpoints, some logic must be implemented to trigger the timing of checkpoints. One category of checkpoint timing techniques contains those that coordinate all constituent components of a system when taking checkpoints. The set of checkpoints taken after such coordination is guaranteed to form a consistent global state of the system for the cost of system-wide coordination. This category of checkpoint techniques is referred to as coordinated checkpoints.

Another category of checkpoint timing techniques includes those where constituent components of a system take their checkpoints without synchronizing with each other. The price to pay for the easiness of checkpointing is the need to find a subset of all taken checkpoints that constitutes a consistent global state of the system. This category of checkpoint techniques is referred to as independent checkpoints.

Hybrid checkpoint techniques attempt to use communication events to trigger the checkpoints in order to combine the benefits of coordinated checkpoints and independent checkpoints. This category of checkpoint techniques is referred to as communication-induced checkpoints.

Regardless of whether checkpoints are transparent, explicit, or implicit, and regardless of whether there is some synchronization required when saving a checkpoint to stable storage or when loading a saved checkpoint back to service, checkpointing techniques rely on two primitive operations. One of these operations is used for saving a checkpoint, while the other operation is used for loading a checkpoint. The amount of state that will be placed in each checkpoint, the suspension of the service execution during saving and loading a checkpoint and the coordination of the saving or loading operations across different services in a system all depend upon the fault tolerance technique that uses checkpoints and the idiosyncrasy of the system (e.g., whether services are involved in nested transactions or copies of the same services are assembled in replica groups). It would therefore be desirable to provide a WSRF-compliant and generic mechanism for taking checkpoints of grid services that addresses some or all of the shortcomings in the above-identified approaches.

### SUMMARY OF THE INVENTION

The present invention provides for a generic, WSRF-compliant checkpointing mechanism for grid services. The mechanism of the present invention is generic because it can be used for any type of application running on a grid and it can be used to implement different checkpoint techniques including transparent, implicit, explicit, coordinated, and communication-induced checkpoints. The mechanism of the present invention is also WSRF-compliant because it can be applied to any WSRF system without necessitating any changes or adaptation of its constituent WSRF services. The checkpoint mechanism of the present invention is based on the information found in the resource properties document. The resource properties document contains the entire state of a WS-Resource as a set of Properties and their values. The mechanism of the present invention comprises operations for retrieving (used to extract state information from a WS-Resource when saving a checkpoint) and updating (used to insert and update state information to a WS-Resource when loading a checkpoint) the values of Properties in the resource properties document of a WS-Resource.

The present invention provides a novel method and system for saving and loading checkpoints of WS-Resources, as the issue of checkpoints has not been previously addressed in WSRF. Compared to other checkpointing mechanisms that have been previously developed, the present invention combines the benefits of saving only relevant state information, as occurs with explicit checkpoints, and refraining from introducing design and coding rules, as is the case with transparent and implicit checkpoints, that would allow the extraction of state information from a running service. The generic, WSRF-compliant checkpoint service of the present invention takes advantage of the fact that WS-Resources have an explicit representation of their state in the resource roperties document. Obtaining the content of the resource properties document (by employing the GetResourcePropertyDocument message as described in the OASIS Web Service Resource Properties specification), the service of the present invention takes a checkpoint with minimum programming effort. In addition, by replacing the current property values of the WD-Resource with the corresponding values that are saved in the checkpoint (by employing the wsrf-rp:PutResourcePropertyDocument message as described in the OASIS Web Service Resource Properties specification), the service of the present invention loads the state saved in a checkpoint back to a service with minimum programming effort. Still further, the present invention provides the benefit of the checkpoint mechanism being specified as a WS-Resource itself, which makes it easy to integrate it with WSRF.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a sequence diagram showing the interactions between the checkpoint service of the present invention and the WS-Resource upon which it is applied for the saveCheckpoint() and the loadCheckpoint() operations;

FIG. 2 is diagram showing the relationship between the checkpoint management service and the target WS-Resources in one embodiment of the present invention.

### DETAILED DESCRIPTION OF THE PREFERRED EMBODIMENTS

The present invention provides for a generic, WSRF-compliant checkpointing mechanism for grid services. In the present invention, the explicit representation of state in WS-Resources is used. A WS-Resource comprises a stateless Web Service and a state represented by a number of WS-Resource Properties, which is the set of resource properties (i.e. individual components of state). A description of the WS-Resource properties can be found at docs.oasis-open.org/wsrf/wsrf-ws_resource_properties-1.2-spec-pr-02.pdf. The WS-Resource Properties are represented as resource property elements in a resource properties document that in turn represents a WS-Resource. A client of a WS-Resource can obtain its property document by issuing a request of type GetResourcePropertyDocument, and it can completely replace the values of a WS-Resource's properties with an entirely new resource properties document by issuing a request of type PutResourcePropertyDocument. A client can also perform individual operations on the properties of a WS-Resource, including but not limited to (1) retrieving the values of one or more properties of the WS-Resource; (2) updating the values of one or more properties of the WS-Resource; and (3) querying across the values of one or more properties of the WS-Resource. The full set of standard operations for WS-Resources can be found in the OASIS Web Service Resource Properties specification (docs.oasis-open.org/wsrf/wsrf-ws_resource_properties-1.2-spec-pr-02.pdf).

The checkpointing mechanism for grid services of the present invention is based upon the information found in a resource properties document. The resource properties document gives the structure of the entire state of a WS-Resource as a set of resource properties and their values. The checkpointing mechanism is based upon the operation GetResourcePropertyDocument for retrieving the state of a WS-Resource and on the PutResourcePropertyDocument operation for loading a previously checkpointed state to a WS-Resource.

The mechanism of the present invention appears as a WS-Resource with a WSDL interface that declares four operations—create the checkpoint management WS-Resource, save a checkpoint, load an checkpoint, and delete a checkpoint—as well as a state that comprises all of the saved checkpoints. The createCheckpoint() operation creates the WS-Resource where the save checkpoints will be stored. The saveCheckpoint() operation takes as a parameter a reference of the WS-Resource that will be checkpointed. Using this reference, it contacts the WS-Resource to obtain the resource properties document and retrieves the structure and the values of the state of the WS-Resource. The contents of the resource properties document (i.e. all of the resource properties and their associated values) forms the data of the checkpoint to be saved. The saveCheckpoint() operation returns a descriptor that uniquely identifies the saved checkpoint within the scope of the WS-Resource that implements the mechanism of the present invention. The deleteCheckpoint() operation takes as a parameter the indentifier of a saved checkpoint and removes the checkpoint associated with the indentifier from the checkpoint management WS-Resource.

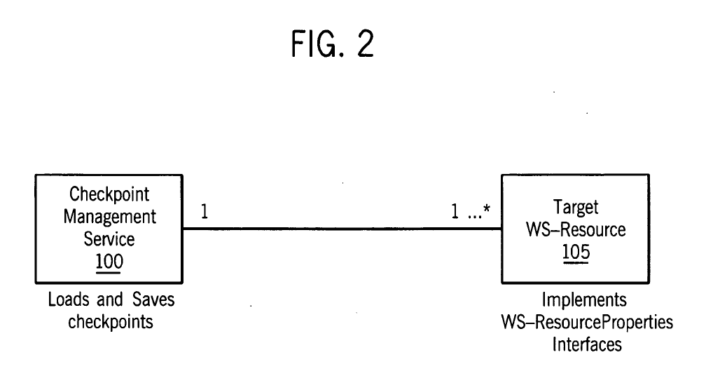

The checkpoint service, also referred to as the checkpoint management service or CMS, is in charge of saving and loading checkpoints to and from the target WS-Resource(s). One CMS instance can control one or more target WS-Resources. The target WS-Resource is accessed by the CMS via the generic WS-ResourceProperties interface defined by WSRF. FIG. 2 illustrates the relationships between a CMS 100 and a target WS-Resource(s) 105.

The Checkpoint Management Service 100 is a WS-Resource that contains all the saved checkpoints. The CMS 100 can extract and save a checkpoint from another WS-Resource and load a saved checkpoint to a WS-Resource. The CMS 100 also provides an external interface (not shown in FIG. 2) that can be used to control the creation of the CMS, saving, loading, and deleting of checkpoints. Other WS-Resources or external clients can use that interface to implement higher-level fault management techniques such as replica groups.

The Checkpoint Management Service 100 implements four external operations: createResource(), saveCheckpoint(), loadCheckpoint() and deleteCheckpoint(). The createResource() operation creates the resource where the checkpoints will be stored. The saveCheckpoint() operation extracts the state from a given WS-Resource 105 and saves it to the local resource. The loadCheckpoint() operation loads the given checkpoint to a given WS-Resource 105 replacing its current state with the checkpointed state. The deleteCheckpoint() operation erases the state corresponding to the indicated checkpoint from the local resource.

The createResource() operation takes no parameters. This operation creates the resource where the checkpoints will be stored and returns the Endpoint Reference (EPR) of the newly created resource. The EPR is a WSResourceReference XML element as defined by the W3C Web Service Addressing candidate recommendation (www.w3.org/TR/ws-addr-core/).

The saveCheckpoint() operation takes as a parameter the EPR of the target WS-Resource 105 that is checkpointed. The EPR uniquely identifies the WS-Resource that is to be checkpointed. The saveCheckpoint() operation returns an integer that uniquely identifies the saved checkpoint within the Checkpoint Management Service 100.

The loadCheckpoint() operation takes as parameters the EPR of the target WS-Resource 105 where the checkpoint is to be loaded and the unique identifier of the checkpoint that is to be loaded. The checkpoint identifier is the integer number returned by the saveCheckpoint() operation. Using the checkpoint descriptor, it retrieves from local storage the structure and the values of the state that corresponds to the checkpoint. Then, the loadCheckpoint() operation issues a PutResourcePropertyDocument request to the WS-Resource indicated by the EPR in its first parameter to replace the WS-Resource's state with the state saved in the indicated checkpoint. The deleteCheckpoint() operation takes as a parameter the unique identifier of the checkpoint to be erased and returns a status code indicating the success of the delete operation or the code of the error that caused the failure of the delete operation.

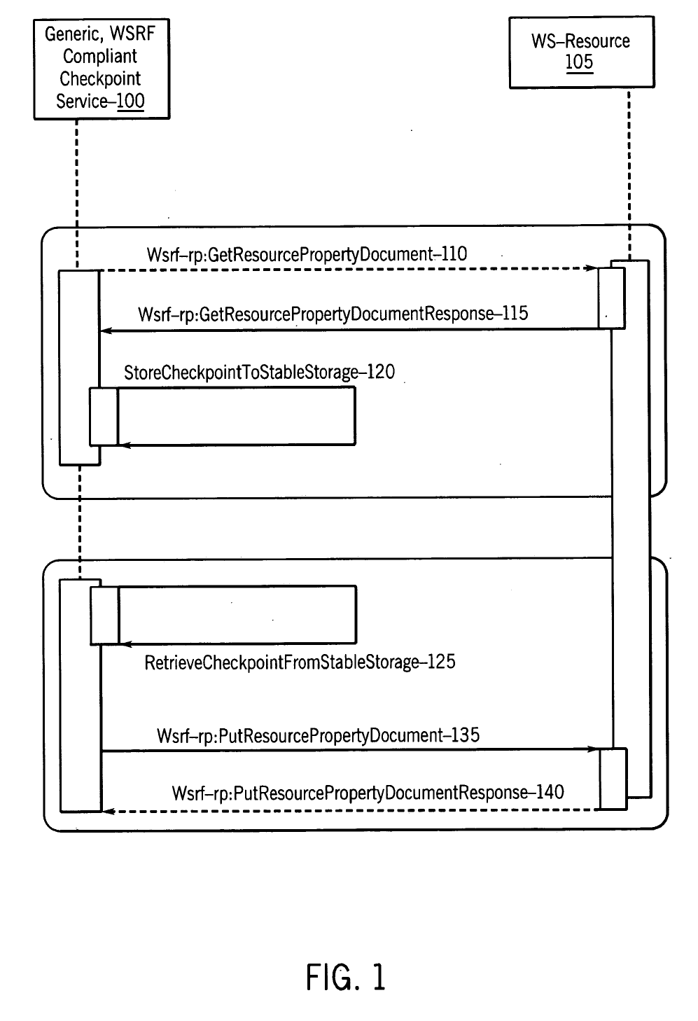

FIG. 1 is a sequence diagram showing the interactions between a checkpoint management service 100 of the present invention and a WS-Resource 105 upon which the checkpoint management service 100 is applied. In the saveCheckpoint() scenario, the checkpoint management service 100 transmits a first wsrf-rp:GetResourcePropertyDocument message 110 to the WS-Resource 105, which responds with a first wsrf-rp:GetResourcePropertyDocumentResponse 115. The checkpoint management service 100 then performs a StoreCheckpointToStableStorage function 120, which saves the information from the wsrf-rp:GetResourcePropertyDocumentResponse 115 with the checkpoint management service 100.

In a subsequent loadCheckpoint() function, the checkpoint management service 100 performs a RetrieveCheckpointFromStableStorage function 125, retrieving the information that was stored during the saveCheckpoint() operation (wsrf-rp:GetResourcePropertyDocumentResponse) 115. The checkpoint management service 100 then places the resource properties document found in the retrieved checkpoint to a wsrf-rp:PutResourcePropertyDocument message 135 and transmits it to the WS-Resource 105. The WS-Resource 105 replaces the current resource properties document with the resource properties document found in the wsrf-rp:PutResourcePropertyDocument message 135 and responds with a wsrf-rp :PutResourcePropertyDocumentResponse 140.

The mechanism of the present invention does not take any action on deleting or overriding checkpoints, or correlating checkpoints that belong to the same WS-Resource or to different WS-Resources that are part of the same distributed computation. This is the responsibility of a system that implements a fault tolerance technique which requires checkpoints and which can be built on top of the checkpointing mechanism of the present invention.

One exemplary implementation of the present invention is implemented in Java and builds on top of the Globus Toolkit (Version 4) reference implementation of the WSRF specification. The Globus Toolkit is developed by the Globus Alliance and released under the Globus Toolkit Public License (GTPL) Version 2 (which can be found at www-unix.globus.org/toolkit/license.html. The toolkit can be found at www-unix.globus.org/toolkit/. Another reference implementation for the WSRF specification is provided by the Apollo open source project. The Apollo project builds a WSRF reference implementation on top of the Apache web server. It should be noted that the Globus Toolkit and Apollo projects could merge to provide a single open source reference implementation of the WSRF specification family. The Apollo project is released under the Apache License, Version 2.0, which can be found at www.apache.org/licenses/LICENSE-2.0, and is available from http://incubator.apache.org/apollo/. In principle, any web service container that implements the WSRF specification could be used as the platform for the present invention, including the Globus Toolkit and the Apollo project. However, an implementation involving the Globus Toolkit is discussed herein.

The main part of the WSDL definition for the Checkpoint Management Service 100 is as follows.

<?xml version=“1.0” encoding=“UTF-8”?>
<definitions name=CheckpointManagementService“

targetNamespace=“http://www.nokia.com/NGF/2005/1/CheckpointManagementService”
xmlns=“http://schemas.xmlsoap.org/wsdl/”
xmlns:tns=“http://www.nokia.com/NGF/2005/1/CheckpointManagementService”
xmlns:wsa=“http://schemas.xmlsoap.org/ws/2004/03/addressing”
xmlns:wsdl=“http://schemas.xmlsoap.org/wsdl/”
xmlns:wsrlw=“http://docs.oasis-open.org/wsrf/2004/06/wsrf-WS-ResourceLifetime-1.2-draft-01.wsdl”
xmlns:wsrp=“http://docs.oasis-open.org/wsrf/2004/06/wsrf-WS-ResourceProperties-12-draft-01.xsd”
xmlns:wsrpw=“http://docs.oasis-open.org/wsrf/2004/06/wsrf-WS-ResourceProperties-1.2-draft-01.wsdl”
xmlns:wsdlpp=http://www.globus.org/namespaces/2004/10/WSDLPreprocessor”
xmlns:xsd=“http://www.w3.org/2001/XMLSchema>

<wsdl:import

namespace=
“http://docs.oasis-open.org/wsrf/2004/06/wsrf-WS-ResourceProperties-1.2-draft-01.wsdl”
location=“../wsrf/properties/WS-ResourceProperties.wsdl”/>

<wsdl:import

namespace=
“http://docs.oasis-open.org/wsrf/2004/06/wsrf-WS-ResourceLifetime-1.2-draft-01.wsdl”
location=“../wsrf/lifetime/WS-ResourceLifetime.wsdl”/>
<types>
<xsd:schema

targetNamespace=“http://www.nokia.com/NGF/2005/1/CheckpointManagementService”
xmlns:tns=“http://www.nokia.com/NGF/2005/1/CheckpointManagementService
xmlns:xsd=“http://www.w3.org/2001/XMLSchema”>
<xsd:import

namespace=“http://schemas.xmlsoap.org/ws/2004/03/addressing”
schemaLocation=“../ws/addressing“WS-Addressing.xsd”/>

<!−− Requests and responses −−>
<xsd:element name=“saveRequest”>

<xsd:complexType>

<xsd:sequence>

<xsd:element ref=“wsa:EndpointReference”/>

</xsd:sequence>

</xsd:complexType>

</xsd:element>
<xsd:element name=“saveResponse” type=“xsd:int/>
<xsd:element name=“loadRequest”

<xsd:complexType>

<xsd:sequence>

<xsd:element ref=“wsa:EndpointReference”/>
<xsd:element name=“CheckpointReference” type=“xsd:int”/>

</xsd:sequence>

</xsd:complexType>

</xsd:element>
<xsd:element name=“loadResponse”>

<xsd:complexType/>

</xsd:element>
<xsd:element name=“deleteRequest”>

<xsd:complexType>

<xsd:sequence>

<xsd:element name=“CheckpointReference” type=“xsd:int”/>

</xsd:sequence>

</xsd:complexType>

</xsd:element>
<xsd:element name=“deleteResponse” type=“xsd:int”/>
<xsd:element name=“createResource”>

<xsd:complexType/>

</xsd:element>
<xsd:element name=“createResourceResponse”>
<xsd:complexType>

<xsd:sequence>

<xsd:element ref=“wsa:EndpointReference”/>

</xsd:sequence>

</xsd:complexType>
</xsd:element>
<!−− Resource properties −−>
<xsd:element name=“Checkpoint”>

<xsd:complexType>

<xsd:sequence>

<xsd:element name=“Identifier” type=“xsd:int”/>
<xsd:element ref=“tns:PropertyDocument”/>

</xsd:sequence>

</xsd:complexType>

</xsd:element>
<xsd:element name=“PropertyDocument”>

<xsd:complexType/>

</xsd:element>
<xsd:element name=“CheckpointManagementResourceProperties”>

<xsd:complexType>

<xsd:sequence>

<xsd:element ref=“tns:Checkpoint” minOccurs=“0” maxOccurs=“unbounded”/>

</xsd:sequence>

</xsd:complexType>

</xsd:element>

</xsd:schema>
</types>
<message name=“CreateResourceRequest”>

<part name=“request” element=“tns:createResource”/>

</message>
<message name=“CreateResourceResponse”>

<part name=“response” element=“tns:createResourceResponse”/>

</message>
<message name=“SaveCheckpointRequest”>

<part name=“parameters” element=“tns:saveRequest”/>

</message>
<message name=“SaveCheckpointResponse”>

<part name=“parameters element=“tns:saveResponse”/>

</message>
<message name=“LoadCheckpointRequest”>

<part name=“parameters” element=“tns:loadRequest”/>

</message>
<message name=“LoadCheekpointResponse”>

<part name=“parameters” element=“tns:loadResponse”/>

</message>
<message name=“DeleteCheckpointRequest”>

<part name=“parameters” element=“tns:deleteRequest”/>

</message>
<message name=“DeleteCheckpointResponse”>

<part name=“parameters” element=“tns:deleteResponse”/>

```
</message>
<portType name=“CheckpointManagementPortType”
    wsdlpp:extends=“wsrpw:GetResourceProperty wsrlw:ImmediateResourceTermination”
    wsrp:ResourceProperties=“tns:CheckpointManagementResourceProperties”>
```

<operation name=“createResource”>

<input message=“tns:CreateResourceRequest”/>
<output message=“tns:CreateResourceResponse”/>

</operation>
<operation name=“saveCheckpoint”>

<input message=“tns:SaveCheckpointRequest”/>
<output message=“tns:SaveCheckpointResponse”/>

</operation>
<operation name=“loadCheckpoint”>

<input message=“tns:LoadCheckpointRequest”/>
<output message=“tns:LoadCheckpointResponse”/>

</operation>
<operation name=“deleteCheckpoint”>

<input message=“tns:DeleteCheckpointRequest”/>
<output message=“tns:DeleteCheckpointResponse”/>

</operation>

</portType>
</definitions>

In the processes discussed herein, it should be noted that the precise syntax of the computer code may vary. In particular, terms other than those used herein can be used to effectuate the intended operations. For example, a term other than SetResourcePropertiesRequest can be used to effectuate the intended function. This also applies to virtually any other specific term identified herein.

The createResource() operation creates an empty resource property document for the CMS and returns the EPR of the resource. If the resource properties document is already created, the method only returns the EPR of the existing resource. The resource properties document is used by the saveCheckpoint() operation to store the checkpoints. The resource is created in the same way as other WS-Resources. An example of resource creation using Globus Toolkit can be found in the Globus Toolkit 4 Programmer's Tutorial at gdp.globus.org/gt4-tutorial/.

The saveCheckpoint() operation uses the wsrf-rp:GetResourcePropertyDocument operation defined in the WS-ResourceProperties specification to retrieve the resource properties document of the target WS-Resource. The WS-ResourceProperties specification can be found at docs.oasis-open.org/wsrf/wsrf-ws _resource_properties-1.2-spec-pr-02.pdf. The resource properties document contains the structure and values of all of the resource properties, or state, of the target WS-Resource. The Checkpoint Management Service 100 then creates a new checkpoint element to its own resource properties document and stores the target WS-Resources resource properties document under the newly created checkpoint element. As an example, if the resource properties document of the target WS-Resource would be presented as follows:

<ServiceProperties>

<tns:NumberOfRequests>22</tns:NumberOfRequests>
<tns:NumberOfFailedRequests>0</tns:NumberOfFailedRequests>
<tns:MeanProcessingTime>120</tns:MeanProcessingTime>

</ServiceProperties>

The corresponding checkpoint entry would be in the following form:

<tns:Checkpoint>
<Identifier>43</Identifier>
<tns:PropertyDocument>
<ServiceProperties>
<tns:NumberOtRequests>22</tns:NumberOfRequests>
<tns:NumberOfFailedRequests>0</tns:NumberOfFailedRequests>
<tns:MeanProcessingTime>120</tns:MeanProcessingTime>
</ServiceProperties>
</tns:PropertyDocument>
</tns:Checkpoint>

The loadCheckpoint() operation finds the requested checkpoint from the resource properties document of the WS-Resource 105 that implements the CMS based on the checkpoint identifier parameter.

The present invention is described in the general context of method steps, which may be implemented in one embodiment by a program product including computer-executable instructions, such as program code, executed by computers in networked environments.

Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule-based logic and other logic to accomplish the various database searching steps, correlation steps, comparison steps and decision steps. It should also be noted that the words “component” and “module” as used herein, and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method of saving and loading checkpoints in a WS-Resource, comprising:
receiving a number of instances of a first resource properties document from the WS-Resource, using a GetResourcePropertyDocument standard WSRF operation, each instance of the first resource properties document identifying a plurality of properties of the WS-Resource at a given moment;
storing the instances of the first resource properties document in distinguishable locations;
retrieving a selected instance of the first resource properties document; and
instructing the WS-Resource to use the selected instance to replace the WS-Resource's current state using a PutResourcePropertyDocument standard WSRF operation.

2. The method of claim 1, further comprising receiving a GetResourcePropertyDocumentResponse message in response to the transmission of a GetResourcePropertyDocument message.

3. The method of claim 1, wherein the first resource property document is received in a first GetResourcePropertyDocumentResponse message in response to a transmitted first GetResourcePropertyDocument message.

4. The method of claim 1, wherein the receiving of a first resource property document from the WS-Resource is part of a save Checkpoint operation.

5. The method of claim 1, wherein the method is implemented in Java and is built on top of a Globus Toolkit.

6. The method of claim 1, wherein the method is built on top of an Apache web server.

7. A computer program product for loading a checkpoint in a WS-Resource, comprising:
computer code for receiving a first resource properties document from the WS-Resource, the first resource properties document identifying a plurality of properties of the WS-Resource at a first moment;
computer code for selecting a saved instance of the first resource properties document; and
computer code instructing the WS-Resource to use the save instance to replace the WS-Resource's current resource properties document.

8. The computer program product of claim 7, further comprising computer code for receiving a PutResourcePropertyDocument response message in response to the transmission of a PutResourcePropertyDocument request message.

9. The computer program product of claim 7, wherein the first resource properties document is received in a first GetResourcePropertyDocumentResponse message in response to a transmitted first GetResourcePropertyDocument request message.

10. The computer program product of claim 7, wherein the receiving of a first resource properties document from the WS-Resource is part of a save Checkpoint operation.

11. The computer program product of claim 7, wherein the checkpoint loading process is implemented in Java and is built on top of a Globus Toolkit.

12. The computer program product of claim 7, wherein the checkpoint loading process is built on top of an Apache web server.

13. A checkpoint service for saving loading a checkpoint in a WS-Resource, comprising:
computer code for receiving a first set of WS-Resource information from the WS-Resource, the first set of WS-Resource information identifying a plurality of properties of the WS-Resource at a first moment;
computer code for retrieving a selected instance of the received resource properties document; and;
computer code for transmitting a PutResourcePropertyDocument request message to the WS-Resource.

14. A checkpoint management service configured to manage checkpoints for a target WS-Resource, comprising:
computer code for implementing a createResource operation, the createResource operation creating a resource where checkpoints for the target WS-resource may be saved;
computer code for implementing a saveCheckpoint operation, the saveCheckpoint operation resulting in the creation of a unique identifier for a saved checkpoint within the created resource; and
computer code for implementing a loadCheckpoint operation, the loadCheckpoint operation loading the saved checkpoint to the target WS-Resource; and
computer code for implementing a deleteCheckpoint operation, the deleteCheckpoint operation deleting an indicated checkpoint from storage of the checkpoint management service.

15. The checkpoint management service of claim 14, wherein the saveCheckpoint operation takes an endpoint reference of the target WS-Resource to be checkpointed.

16. The checkpoint management service of claim 14, wherein the loadCheckpoint operation comprises:
obtaining from local storage the resource properties of the target WS-Resource at the time of the saved checkpoint; and
using a PutResourcePropertyDocument request to load the obtained resource properties to the target web resource.

17. The checkpoint management service of claim 14, wherein the service is implemented in Java and is built on top of a Globus Toolkit.

18. The checkpoint management service of claim 14, wherein the service is built on top of an Apache web server.
